(19) United States
(12) Patent Application Publication
(10) Pub. No.: US 2024/0157654 A1
(43) Pub. Date: May 16, 2024

(54) METHOD FOR IMPROVING FINENESS OF SPECIFIED REGION ON SURFACE OF LIGHT-CURABLE 3D PRINTED MODEL

(71) Applicant: SHENZHEN CBD TECHNOLOGY CO., LTD., Shenzhen, Guangdong (CN)

(72) Inventors: Yu YI, Shenzhen, Guangdong (CN); Xinfu XIE, Shenzhen, Guangdong (CN); Li LIU, Shenzhen, Guangdong (CN); Shaohua LING, Shenzhen, Guangdong (CN)

(73) Assignee: SHENZHEN CBD TECHNOLOGY CO., LTD., Shenzhen, Guangdong (CN)

(21) Appl. No.: 18/548,581

(22) PCT Filed: Jul. 14, 2021
(86) PCT No.: PCT/CN2021/106298

§ 371 Date: Sep. 1, 2023

(30) Foreign Application Priority Data
Mar. 23, 2021 (CN) 202110307685.4

(51) Int. Cl. B29C 64/393; B29C 64/129; B33Y 50/02; G06T 5/70; G06T 5/73; G06T 19/00

(52) U.S. Cl. CPC B29C 64/393; B29C 64/129; B33Y 50/02; G06T 5/70; G06T 5/73; G06T 19/00; G06T 2219/008

(57) ABSTRACT

The present application provides eight methods for improving the fineness of a specified region on the surface of a light-curable 3D printed model. In Methods 1-4, an anti-aliasing function is turned on/an image edge blurring function may be turned on entirely for a puppet 3D model, which can make the overall surface of the printed model smooth and flat. In addition, a specified region on the model surface may be circled, and an image sharpening function is turned on/the anti-aliasing function is turned off/the image edge blurring function is turned off to retain a marginal sawtooth effect of the sliced image in the specified region, so that specific feature lines of the printed model surface are obviously prominent, and the fineness of the specific features in the specified region of the model surface can be improved. In Methods 5-8 of the present invention, thinner and smaller slice layer parameters are set for the slice layer where the specified region is located on the basis of Methods 1-4, so that the sense of stepped teeth on the surface of the printed model in a Z-axis direction is weaker, thereby further improving the fineness of specific features in the specified region of the model surface.

The present application is based on and claims priority to Chinese Patent Application No. 202110307685.4, filed on Mar. 23, 2021 and entitled “METHOD FOR IMPROVING FINENESS OF SPECIFIED REGION ON SURFACE OF LIGHT-CURABLE 3D PRINTED MODEL”, the disclosure of which is herein incorporated by reference in its entirety.

### TECHNICAL FIELD

The present application relates to the technical field of 3D (3-dimension) printing, in particular to a method for improving the fineness of a specified region on the surface of a light-curable 3D printed model.

### BACKGROUND

At present, in the existing light-curable 3D printing, factors affecting the appearance fineness of a printed model are mainly affected by two aspects: firstly, in a Z-axis direction, the larger the layer thickness when a slice is set, the more obvious the sense of stepped teeth on the surface of the printed model in the Z-axis direction; and secondly, affected by a pixel resolution of a mask translucent screen on an XY plane, the lower the resolution, the more obvious marginal sawteeth on a mask image produced by UV light transmission through the mask translucent screen, so the more obvious marginal sawteeth of the printed model on the XY plane. Under normal circumstances, the former sets a smaller layer thickness in a slice preprocessing link of a 3D printed model to make the surface of the printed model present a more delicate sense of fineness in the Z-axis direction, while the latter needs to turn on an anti-aliasing function/image edge blurring function in the slice preprocessing link of the 3D printed model under the condition that the resolution of the mask translucent screen cannot be changed, so that marginal sawteeth on the mask image can achieve a gradient transition under the condition that pixel grayscale gradients are naturally engaged, so as to eliminate a clear sawtooth sense caused by the color mutation between the sawteeth. Its general implementation principle is that after the 3D model is sliced according to the specified layer thickness on the Z axis, each layer of slice contains a mask image of the XY plane, and if the anti-aliasing function/image edge blurring function is turned on for the mask image, the marginal sawteeth on a model molded resin layer during printing tend to be blurred; and if the anti-aliasing function/the image edge blurring function is not turned on for the mask image, the marginal sawteeth on the mask image are clear, while the marginal sawteeth on the model molded resin layer during UV curing printing are also clear.

However, when current 3D printed model slice preprocessing software turns on the anti-aliasing function/turns on the image edge blurring function for a model, the anti-aliasing setting/image edge blurring setting can only be performed uniformly for the entire model, so that mask images of all slice layers of a 3D model produce marginal sawteeth on the XY plane; and in the face of a model with relatively simple surface details and structural features of the 3D model, the anti-aliasing/image edge blurring function may be turned on uniformly to make the printed model surface smooth and flat. However, in the face of puppet 3D models, especially for human eyes and eyebrows, their surface details and structural features are numerous, while appearance lines are more complicated. At this time, if the anti-aliasing/image edge blurring function is also turned on uniformly, the grayscale values of sawtooth margins of the mask image change from distinct black and white to gradient transition, which will make a distinct black and white light transmission effect of pixels in the sawtooth positions of the mask light translucent screen also become a gradient state. Correspondingly, photosensitive resin molded voxels whose pixel positions are irradiated by UV will also have insufficient solidification molding reaction, resulting in mutual fusion and merging between the voxels, such that positions with deep trenches on the surface of the printed model will be filled to become shallow after printing, while positions with shallow trenches will be filled to become light in color after printing. This makes outer lines less visible, makes the positions less fine, and also weakens the line sense caused by light shadows.

### Technical Problem

In order to solve the problems in the above background technology, the present invention provides eight methods for improving the fineness of a specified region on the surface of a light-curable 3D printed model.

### Technical Solution

Based on the above content, it can be seen that when a puppet 3D model with more surface details and structural features is preprocessed, it is necessary to turn on an anti-aliasing function/image edge blurring function for parts other than the specified region, and also turn off the anti-aliasing function/turn off the image edge blurring function for the specified region. On this basis, thinner and smaller slice layer parameters may also be set for a slice layer where the specified region is located, so that the sense of stepped teeth on the surface of the printed model in a Z-axis direction is weaker, so as to further improve the fineness of the specified region on the surface of the light-curable 3D printed model. Therefore, in response to this situation, it is necessary to provide a method for specifically improving the fineness of the specified region on the surface of the light-curable 3D printed model. The technical scheme adopted in the present invention is as follows:

In Methods 1-4, an anti-aliasing function is turned on/an image edge blurring function may be turned on entirely for a puppet 3D model, which can make the overall surface of the printed model smooth and flat. In addition, a specified region on the model surface may be circled, and an image sharpening function is turned on/the anti-aliasing function is turned off/the image edge blurring function is turned off to retain a marginal sawtooth effect of the sliced image in the specified region, so that specific feature lines of the printed model surface are obviously prominent, and the fineness of the specific features in the specified region of the model surface can be improved. In Methods 5-8 of the present invention, thinner and smaller slice layer parameters are set for the slice layer where the specified region is located on the basis of Methods 1-4, so that the sense of stepped teeth on the surface of the printed model in a Z-axis direction is weaker, thereby further improving the fineness of specific features in the specified region of the model surface.

In Method 1, a positive selection mode is adopted, in which an anti-aliasing/image edge blurring function is turned on entirely for the model surface, a first region is then delimited as a specified region, and an image sharpening function is turned on/an anti-aliasing function is turned off/an image edge blurring function is turned off. The Method 1 includes the following steps:
loading and opening a 3D model through 3D printing slicing software;
turning on an anti-aliasing/image edge blurring function for the 3D model through the 3D printing slicing software;
manually delimiting the first region on the surface of the 3D model according to specific features of the 3D model through the 3D printing slicing software, and turning on an image sharpening function/turning off an anti-aliasing function/turning off an image edge blurring function; and
slicing the 3D model through the 3D printing slicing software, and importing slicing data of the 3D model, which is generated after slicing, into a light-curable printer for light-curable printing.

In Method 2, an inverse selection mode is adopted, in which a first region is delimited on the surface of the model as a specified region, a second region is inversely selected as a non-specified region with the first region as a reference, and an anti-aliasing function is turned on/an image edge blurring function is turned on for the non-specified region. The Method 2 includes the following steps:
loading and opening a 3D model through 3D printing slicing software;
manually delimiting the first region on the surface of the 3D model according to specific features of the 3D model through the 3D printing slicing software;
inversely selecting the second region on the surface of the 3D model with the first region as a reference through the 3D printing slicing software, and turning on an anti-aliasing function/turning on an image edge blurring function for the second region; and
slicing the 3D model through the 3D printing slicing software, and importing slicing data of the 3D model, which is generated after slicing, into a light-curable printer for light-curable printing.

In Method 3, a parallel selection mode is adopted, in which a first region and a second region are delimited on the model surface, and an anti-aliasing/image edge blurring function is turned on for only the second region. The Method 3 further includes the following steps:
loading and opening a 3D model through 3D printing slicing software;
manually delimiting the first region and the second region on the surface of the 3D model according to specific features of the 3D model through the 3D printing slicing software;
turning on an anti-aliasing/image edge blurring function for the second region through the 3D printing slicing software; and
slicing the 3D model through the 3D printing slicing software, and importing slicing data of the 3D model, which is generated after slicing, into a light-curable printer for light-curable printing.

In Method 4, a parallel selection mode is adopted, in which a first region and a second region are delimited on the model surface, the first region is then used as the specified region and an image sharpening function is turned on for the first region, and the second region is then used as a non-specified region and an anti-aliasing/image edge blurring function is turned on for the second region. The Method 4 includes the following steps:
loading and opening a 3D model through 3D printing slicing software;
manually delimiting the first region and the second region on the surface of the 3D model according to specific features of the 3D model through the 3D printing slicing software;
turning on an image sharpening function for the first region through the 3D printing slicing software; and
turning on an anti-aliasing/image edge blurring function for the second region through the 3D printing slicing software; and
slicing the 3D model through the 3D printing slicing software, and importing slicing data of the 3D model, which is generated after slicing, into a light-curable printer for light-curable printing.

In Method 5, a positive selection mode is adopted, in which an anti-aliasing/image edge blurring function is first turned on entirely for the model surface, a first region is then delimited as a specified region and an image sharpening function is turned on/an anti-aliasing function is turned off/an image edge blurring function is turned off, a second layer thickness parameter is then set entirely for the model, and a first slice layer thickness parameter is then set for a slice layer where the first region is located. The Method 5 includes the following steps:
loading and opening a 3D model through 3D printing slicing software;
turning on an anti-aliasing/image edge blurring function for the 3D model through the 3D printing slicing software;
manually delimiting the first region on the surface of the 3D model according to specific features of the 3D model through the 3D printing slicing software, and turning on an image sharpening function/turning off an anti-aliasing function/turning off an image edge blurring function; and
setting a second slice layer thickness parameter entirely for the 3D model through the 3D printing slicing software;
setting a first slice layer thickness parameter for the slice layer where the first region is located through the 3D printing slicing software; and
slicing the 3D model through the 3D printing slicing software, and importing slicing data of the 3D model, which is generated after slicing, into a light-curable printer for light-curable printing.

In Method 6, an inverse selection mode is adopted, in which a first region is delimited on the model surface as a specified region, a second region is inversely selected as a non-specified region with the first region as a reference, and an anti-aliasing function/image edge blurring function is turned on for the non-specified region, a second layer thickness parameter is then set entirely for the model, and a first slice layer thickness parameter is then set for a slice layer where the first region is located. The Method 6 includes the following steps:
loading and opening a 3D model through 3D printing slicing software;
manually delimiting the first region on the surface of the 3D model according to specific features of the 3D model through the 3D printing slicing software;
inversely selecting the second region on the surface of the 3D model with the first region as a reference through the 3D printing slicing software, and turning on an anti-aliasing function/turning on an image edge blurring function for the second region;
setting a second slice layer thickness parameter entirely for the 3D model through the 3D printing slicing software;
setting a first slice layer thickness parameter for the slice layer where the first region is located through the 3D printing slicing software; and
slicing the 3D model through the 3D printing slicing software, and importing slicing data of the 3D model, which is generated after slicing, into a light-curable printer for light-curable printing.

In Method 7, a parallel selection mode is adopted, in which a first region and a second region are delimited on the model surface, an anti-aliasing function/image edge blurring function is then turned on for the second region only, a second layer thickness parameter is then set entirely for the model, and a first slice layer thickness parameter is then set for a slice layer where the first region is located. The Method 7 includes the following steps:
loading and opening a 3D model through 3D printing slicing software;
manually delimiting the first region and the second region on the surface of the 3D model according to specific features of the 3D model through the 3D printing slicing software;
turning on an anti-aliasing/image edge blurring function for the second region through the 3D printing slicing software; and
setting a second slice layer thickness parameter entirely for the 3D model through the 3D printing slicing software;
setting a first slice layer thickness parameter for the slice layer where the first region is located through the 3D printing slicing software; and
slicing the 3D model through the 3D printing slicing software, and importing slicing data of the 3D model, which is generated after slicing, into a light-curable printer for light-curable printing.

In Method 8, a parallel selection mode is adopted, in which a first region and a second region are delimited on the model surface, the first region is then used as a specified region and an image sharpening function is turned on for the specified region, the second region is then used as a non-specified region and an anti-aliasing function/image edge blurring function is turned on for the non-specified region, a second layer thickness parameter is then set entirely for the model, and a first slice layer thickness parameter is then set for a slice layer where the first region is located. The Method 8 includes the following steps:
loading and opening a 3D model through 3D printing slicing software;
manually delimiting the first region and the second region on the surface of the 3D model according to specific features of the 3D model through the 3D printing slicing software;
turning on an image sharpening function for the first region through the 3D printing slicing software; and
turning on an anti-aliasing/image edge blurring function for the second region through the 3D printing slicing software; and
setting a second slice layer thickness parameter entirely for the 3D model through the 3D printing slicing software;
setting a first slice layer thickness parameter for the slice layer where the first region is located through the 3D printing slicing software; and
slicing the 3D model through the 3D printing slicing software, and importing slicing data of the 3D model, which is generated after slicing, into a light-curable printer for light-curable printing.

As a preferred scheme, an anti-aliasing level in the anti-aliasing function is level 2, or level 4, or level 8.

As a preferred scheme, the number of gray levels of pixels at the transition of the sawtooth edge in the anti-aliasing function is any natural number from 0 to 8.

As a preferred scheme, the number of levels of image blurring pixels in the image edge blurring function is 2, or 3, or 4.

As a preferred scheme, the first region is a closed region, the number of the first region is one, or more.

As a preferred scheme, the mode of manually delimiting the first region or the second region through the 3D printing slicing software comprises: performing a line closure lasso selection through a line closure lasso selection tool, or performing a box selection through a box selection tool, or performing a solid intersection selection by a spherical solid intersection tool, or performing a boolean inverse selection through a Boolean selection tool, or performing a coloring selection through a coloring tool, or performing coordinate closure enclosing through inputted coordinate points, or performing a surface projection selection through a projection tool.

As a preferred scheme, the 3D model slicing data generated after the 3D model is sliced is used for light-curable printing though a Liquid Crystal Display (LCD) light-curing 3D printer, or a Digital Light Processing (DLP) light-curing 3D printer, or a Continuous Liquid Interface Production (CLIP) light-curing 3D printer.

### Beneficial Effects

1. In Methods 1˜4 of the present invention, an anti-aliasing function is turned on entirely for a puppet 3D model, which can make the overall surface of the printed model smooth and flat; and an image edge blurring function is turned on entirely for the puppet 3D model, so that multi-layer grayscale gradient sawteeth appear at the edge of a sliced image, and the surface finish and flatness of some parts other than the specified region of the printed model can be further improved. It is possible to circle the specified region on the model surface, and turn on an image sharpening function/turn off an anti-aliasing function/turn off an image edge blurring function to retain a marginal sawtooth effect of the sliced image in the specified region, making specific feature lines stand out obviously, thereby improving the fineness of specific features in the specified region on the model surface.

2. In Methods 5-8 of the present invention, thinner and smaller slice layer parameters are set for the slice layer where the specified region is located on the basis of Methods 1-4, so that the sense of stepped teeth on the surface of the printed model in the Z-axis direction is weaker, thereby further improving the fineness of specific features in the specified region of the model surface.

3. A positive selection mode is adopted in Method 1 of the present invention, in which an image sharpening function is turned on for the specified region, so that the black and white contrast of the marginal sawteeth on the image is more vivid, resulting in enhanced marginal sawtooth effect, thereby further improving the fineness of specific features on the specified region of the model surface. A uniform first layer thickness is set for the entire model on the basis of Method 5, and then another separate second layer thickness is set for the slice layer where the specified region is located, so that the thickness of each printed layer of slice in the specified region is thinner, resulting in weaker sense of stepped teeth in the Z-axis direction, thereby improving the printing fineness.

4. An inverse selection mode is adopted in Method 2 of the present invention, in which an image sharpening function may not be turned on for the specified region, but an anti-aliasing/image edge blurring function can be turned off, so that original grayscale values of pixels of marginal sawteeth on the image are retained, which is conducive to maintaining the fineness of the specified region of the model itself. On the basis of this, in Method 6, a uniform first layer thickness is first set for the entire model, and then another separate second layer thickness is set for the slice layer where the specified region is located, so that the thickness of each printed layer of slice in the specified region is thinner, resulting in weaker sense of stepped teeth in the Z-axis direction, thereby improving the printing fineness.

5. A parallel selection mode is adopted in Method 3 of the present invention, in which the model surface is divided into a first region and a second region, so as to facilitate the first region and the second region to separately and directly set functional properties, which may also be set together with other printing parameters according to their respective regions. For example, a slice layer thickness may be specified separately for a layer where the first region is located, and an anti-aliasing function may not be turned on; and a slice layer thickness may be specified separately for the second region, and an anti-aliasing function may be turned on. Such software operation settings are more intuitive and simple to operate, and easy to understand. On this basis, in Method 7, a uniform first layer thickness is set for the entire model, and then another separate second layer thickness is set for the slice layer where the specified region is located, so that the thickness of each printed layer of slice in the specified region is thinner, resulting in weaker sense of stepped teeth in the Z-axis direction, thereby improving the printing fineness.

6. A parallel selection mode is adopted in Method 4 of the present invention, in which the model surface is divided into a first region and a second region, so as to facilitate the first region and the second region to separately and directly set functional properties; and an image sharpening function may be turned on for the specified region, such that the black and white contrast of the marginal sawteeth on the image is more vivid, such that the marginal sawtooth effect is enhanced. The functional properties may also be set together with other printing parameters according to their respective regions. For example, a slice layer thickness may be specified separately for a layer where the first region is located, and an image sharpening function may be turned on; and a slice layer thickness may be specified separately for the second region, and an anti-aliasing function may be turned on. Such software operation settings are more intuitive and simple to operate, and easy to understand. On this basis, in Method 8, a uniform first layer thickness is set for the entire model, and then another separate second layer thickness is set for the slice layer where the specified region is located, so that the thickness of each printed layer of slice in the specified region is thinner, resulting in weaker sense of stepped teeth in the Z-axis direction, thereby improving the printing fineness.

### BRIEF DESCRIPTION OF THE DRAWINGS

FIG. 1 is a flowchart of Method 1 for improving the fineness of a specified region on the surface of a light-curable 3D printed model according to the present invention;

FIG. 2 is a flowchart of Method 2 for improving the fineness of a specified region on the surface of a light-curable 3D printed model according to the present invention;

FIG. 3 is a flowchart of Method 3 for improving the fineness of a specified region on the surface of a light-curable 3D printed model according to the present invention;

FIG. 4 is a flowchart of Method 4 for improving the fineness of a specified region on the surface of a light-curable 3D printed model according to the present invention;

FIG. 5 is a flowchart of Method 5 for improving the fineness of a specified region on the surface of a light-curable 3D printed model according to the present invention;

FIG. 6 is a flowchart of Method 6 for improving the fineness of a specified region on the surface of a light-curable 3D printed model according to the present invention;

FIG. 7 is a flowchart of Method 7 for improving the fineness of a specified region on the surface of a light-curable 3D printed model according to the present invention;

FIG. 8 is a flowchart of Method 8 for improving the fineness of a specified region on the surface of a light-curable 3D printed model according to the present invention;

FIG. 9 is a puppet model diagram of a method for improving the fineness of a specified region on the surface of a light-curable 3D printed model according to the present invention;

FIG. 10 is a model slice diagram 1 of a method for improving the fineness of a specified region on the surface of a light-curable 3D printed model according to the present invention;

FIG. 11 is a specific slice diagram of a method for improving the fineness of a specified region on the surface of a light-curable 3D printed model according to the present invention;

FIG. 12 is a slice mask diagram 1 of a method for improving the fineness of a specified region on the surface of a light-curable 3D printed model according to the present invention;

FIG. 13 is an embodiment of Method 1 or 5 for improving the fineness of a specified region on the surface of a light-curable 3D printed model according to the present invention;

FIG. 14 is an embodiment of Method 2 or 6 for improving the fineness of a specified region on the surface of a light-curable 3D printed model according to the present invention;

FIG. 15 is an embodiment of Method 3 or 7 for improving the fineness of a specified region on the surface of a light-curable 3D printed model according to the present invention;

FIG. 16 is an embodiment of Method 4 or 8 for improving the fineness of a specified region on the surface of a light-curable 3D printed model according to the present invention;

FIG. 17 is a model slice diagram 2 of a method for improving the fineness of a specified region on the surface of a light-curable 3D printed model according to the present invention;

FIG. 18 is a slice mask diagram 2 of a method for improving the fineness of a specified region on the surface of a light-curable 3D printed model according to the present invention;

FIG. 19 is a model printing apparatus 1 for 3D model slicing data generated after slicing by a method of the present invention;

FIG. 20 is a model printing apparatus 2 for 3D model slicing data generated after slicing by a method of the present invention;

FIG. 21 is Embodiment 1 of a method for improving the fineness of a specified region on the surface of a light-curable 3D printed model according to the present invention;

FIG. 22 is Embodiment 2 of a method for improving the fineness of a specified region on the surface of a light-curable 3D printed model according to the present invention;

FIG. 23 is Embodiment 1 of an apparatus for improving the fineness of a specified region on the surface of a light-curable 3D printed model according to the present invention;

FIG. 24 is a variant of Embodiment 1 of the apparatus for improving the fineness of the specified region on the surface of the light-curable 3D printed model according to the present invention;

FIG. 25 is Embodiment 2 of an apparatus for improving the fineness of a specified region on the surface of a light-curable 3D printed model according to the present invention;

FIG. 26 is a schematic structural diagram of a second surface processing module provided by an embodiment of the present invention;

FIG. 27 is a variant of Embodiment 2 of the apparatus for improving the fineness of the specified region on the surface of the light-curable 3D printed model according to the present invention;

FIG. 28 is another variant of Embodiment 2 of the apparatus for improving the fineness of the specified region on the surface of the light-curable 3D printed model according to the present invention; and

FIG. 29 is a schematic structural diagram of a terminal apparatus provided by an embodiment of the present invention.

Reference symbols represents the following components:
1—controller; 2—LCD screen; 21—mask image translucent channel; 22—mask image occlusion shadow; 3—motor; 31—lifting column; 4—external storage unit; 5—UVLED light source module; 6—display and operation unit; 7—molding platform; 8—liquid tank; 80—bottom film; 81—photosensitive resin; 82—model molded resin layer; 9—base; 230—projection apparatus; 100—first region; 200—second region; 101—first model loading and opening module; 102—first function turning-on module; 103—first surface processing module; 104—first data importing module; 105—first overall parameter setting module; 106—first layer parameter setting module; 201—second model loading and opening module; 202—second function turning-on module; 203—second surface processing module; 204—second data importing module; 2031—surface delimiting submodule; 2032—inverse selection submodule; 205—sharpening function turning-on module; 206—second overall parameter setting module; 207—second layer parameter setting module; 29—terminal device; 290—processor; 291—memory; 292—computer program.

### DETAILED DESCRIPTION

Embodiments of the present invention will be further explained below in conjunction with the accompanying drawings.

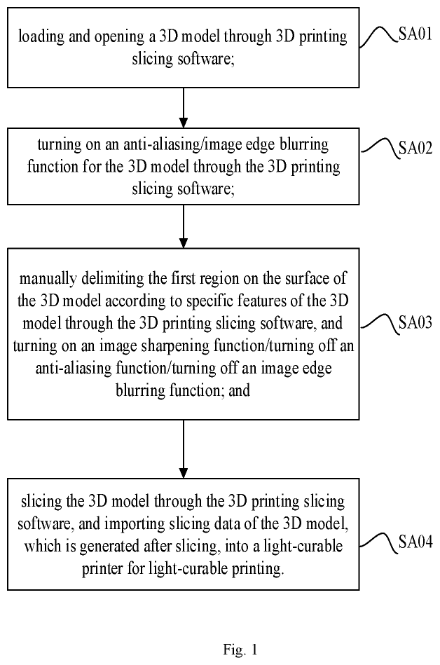

FIG. 1 is a flowchart of Method 1 for improving the fineness of a specified region on the surface of a light-curable 3D printed model according to the present invention. As shown in FIG. 1, a positive selection mode is adopted, in which an anti-aliasing/image edge blurring function is turned on entirely for the model surface, a first region is then delimited as a specified region, and an image sharpening function is turned on/an anti-aliasing function is turned off/an image edge blurring function is turned off. The Method 1 includes the following steps:
SA01: loading and opening a 3D model through 3D printing slicing software;
SA02: turning on an anti-aliasing/image edge blurring function for the 3D model through the 3D printing slicing software;
SA03: manually delimiting the first region on the surface of the 3D model according to specific features of the 3D model through the 3D printing slicing software, and turning on an image sharpening function/turning off an anti-aliasing function/turning off an image edge blurring function; and
SA04: slicing the 3D model through the 3D printing slicing software, and importing slicing data of the 3D model, which is generated after slicing, into a light-curable printer for light-curable printing.

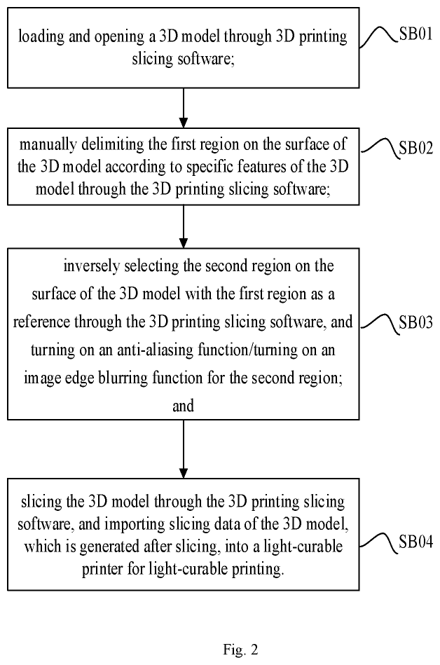

FIG. 2 is a flowchart of Method 2 for improving the fineness of a specified region on the surface of a light-curable 3D printed model according to the present invention. As shown in FIG. 2, an inverse selection mode is adopted, in which a first region is delimited on the surface of the model as a specified region, a second region is inversely selected as a non-specified region with the first region as a reference, and an anti-aliasing function is turned on/an image edge blurring function is turned on for the non-specified region. The Method 2 includes the following steps:
SB01: loading and opening a 3D model through 3D printing slicing software;
SB02: manually delimiting the first region on the surface of the 3D model according to specific features of the 3D model through the 3D printing slicing software;
SB03: inversely selecting the second region on the surface of the 3D model with the first region as a reference through the 3D printing slicing software, and turning on an anti-aliasing function/turning on an image edge blurring function for the second region; and
SB04: slicing the 3D model through the 3D printing slicing software, and importing slicing data of the 3D model, which is generated after slicing, into a light-curable printer for light-curable printing.

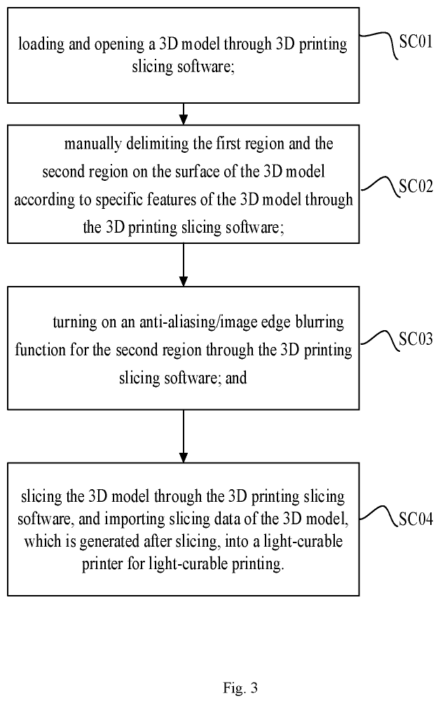

FIG. 3 is a flowchart of Method 3 for improving the fineness of a specified region on the surface of a light-curable 3D printed model according to the present invention. As shown in FIG. 3, a parallel selection mode is adopted, in which a first region and a second region are delimited on the model surface, and an anti-aliasing/image edge blurring function is turned on for only the second region. The Method 3 further includes the following steps:
SC01: loading and opening a 3D model through 3D printing slicing software;
SC02: manually delimiting the first region and the second region on the surface of the 3D model according to specific features of the 3D model through the 3D printing slicing software;
SC03: turning on an anti-aliasing/image edge blurring function for the second region through the 3D printing slicing software; and
SC04: slicing the 3D model through the 3D printing slicing software, and importing slicing data of the 3D model, which is generated after slicing, into a light-curable printer for light-curable printing.

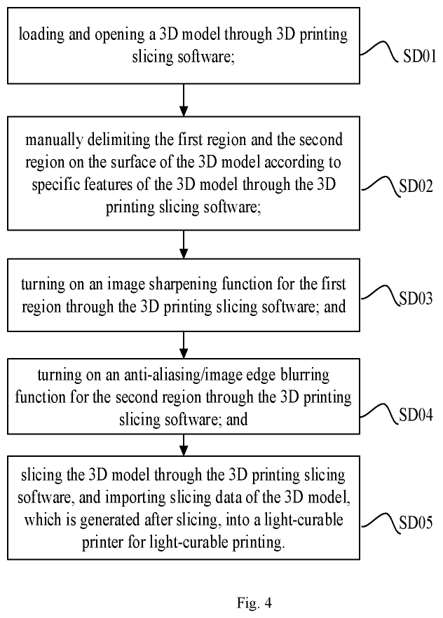

FIG. 4 is a flowchart of Method 4 for improving the fineness of a specified region on the surface of a light-curable 3D printed model according to the present invention. As shown in FIG. 4, a parallel selection mode is adopted, in which a first region and a second region are delimited on the model surface, the first region is then used as the specified region and an image sharpening function is turned on for the first region, and the second region is then used as a non-specified region and an anti-aliasing/image edge blurring function is turned on for the second region. The Method 4 includes the following steps:
SD01: loading and opening a 3D model through 3D printing slicing software;
SD02: manually delimiting the first region and the second region on the surface of the 3D model according to specific features of the 3D model through the 3D printing slicing software;
SD03: turning on an image sharpening function for the first region through the 3D printing slicing software; and
SD04: turning on an anti-aliasing/image edge blurring function for the second region through the 3D printing slicing software; and
SD05: slicing the 3D model through the 3D printing slicing software, and importing slicing data of the 3D model, which is generated after slicing, into a light-curable printer for light-curable printing.

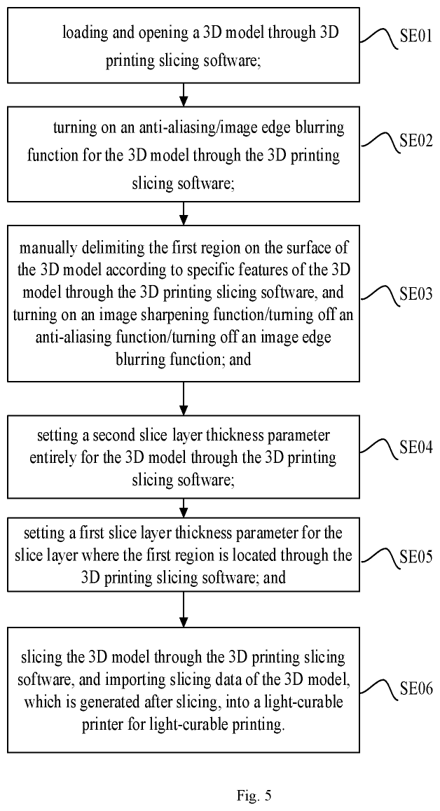

FIG. 5 is a flowchart of Method 5 for improving the fineness of a specified region on the surface of a light-curable 3D printed model according to the present invention. As shown in FIG. 5, a positive selection mode is adopted, in which an anti-aliasing/image edge blurring function is first turned on entirely for the model surface, a first region is then delimited as a specified region and an image sharpening function is turned on/an anti-aliasing function is turned off/an image edge blurring function is turned off, a second layer thickness parameter is then set entirely for the model, and a first slice layer thickness parameter is then set for a slice layer where the first region is located. The Method 5 includes the following steps:
SE01: loading and opening a 3D model through 3D printing slicing software;
SE02: turning on an anti-aliasing/image edge blurring function for the 3D model through the 3D printing slicing software;
SE03: manually delimiting the first region on the surface of the 3D model according to specific features of the 3D model through the 3D printing slicing software, and turning on an image sharpening function/turning off an anti-aliasing function/turning off an image edge blurring function; and
SE04: setting a second slice layer thickness parameter entirely for the 3D model through the 3D printing slicing software;
SE05: setting a first slice layer thickness parameter for the slice layer where the first region is located through the 3D printing slicing software; and
SE06: slicing the 3D model through the 3D printing slicing software, and importing slicing data of the 3D model, which is generated after slicing, into a light-curable printer for light-curable printing.

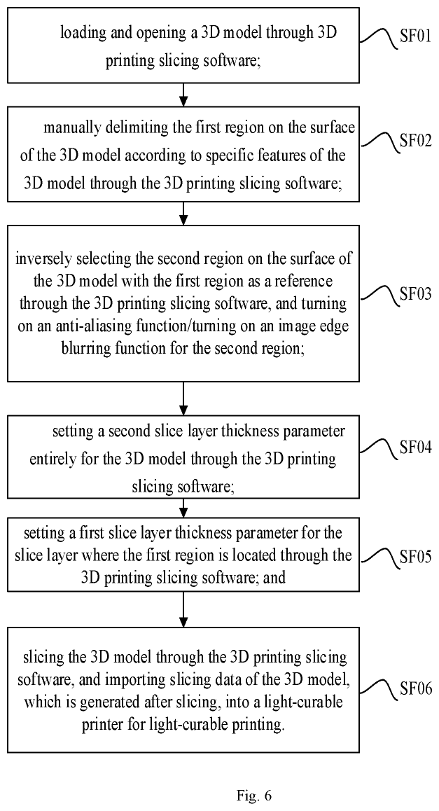

FIG. 6 is a flowchart of Method 6 for improving the fineness of a specified region on the surface of a light-curable 3D printed model according to the present invention. As shown in FIG. 6, an inverse selection mode is adopted, in which a first region is delimited on the model surface as a specified region, a second region is inversely selected as a non-specified region with the first region as a reference, and an anti-aliasing function/image edge blurring function is turned on for the non-specified region, a second layer thickness parameter is then set entirely for the model, and a first slice layer thickness parameter is then set for a slice layer where the first region is located. The Method 6 includes the following steps:
SF01: loading and opening a 3D model through 3D printing slicing software;
SF02: manually delimiting the first region on the surface of the 3D model according to specific features of the 3D model through the 3D printing slicing software;
SF03: inversely selecting the second region on the surface of the 3D model with the first region as a reference through the 3D printing slicing software, and turning on an anti-aliasing function/turning on an image edge blurring function for the second region;
SF04: setting a second slice layer thickness parameter entirely for the 3D model through the 3D printing slicing software;
SF05: setting a first slice layer thickness parameter for the slice layer where the first region is located through the 3D printing slicing software; and
SF06: slicing the 3D model through the 3D printing slicing software, and importing slicing data of the 3D model, which is generated after slicing, into a light-curable printer for light-curable printing.

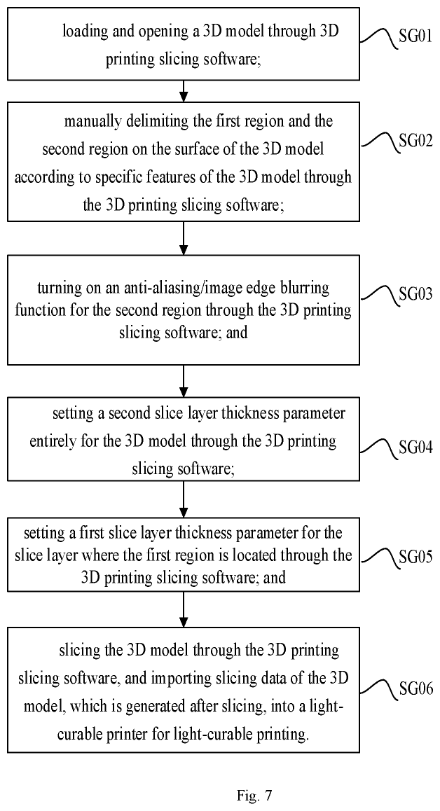

FIG. 7 is a flowchart of Method 7 for improving the fineness of a specified region on the surface of a light-curable 3D printed model according to the present invention. As shown in FIG. 7, a parallel selection mode is adopted, in which a first region and a second region are delimited on the model surface, an anti-aliasing function/image edge blurring function is then turned on for the second region only, a second layer thickness parameter is then set entirely for the model, and a first slice layer thickness parameter is then set for a slice layer where the first region is located. The Method 7 includes the following steps:
SG01: loading and opening a 3D model through 3D printing slicing software;
SG02: manually delimiting the first region and the second region on the surface of the 3D model according to specific features of the 3D model through the 3D printing slicing software;
SG03: turning on an anti-aliasing/image edge blurring function for the second region through the 3D printing slicing software; and
SG04: setting a second slice layer thickness parameter entirely for the 3D model through the 3D printing slicing software;
SG05: setting a first slice layer thickness parameter for the slice layer where the first region is located through the 3D printing slicing software; and
SG06: slicing the 3D model through the 3D printing slicing software, and importing slicing data of the 3D model, which is generated after slicing, into a light-curable printer for light-curable printing.

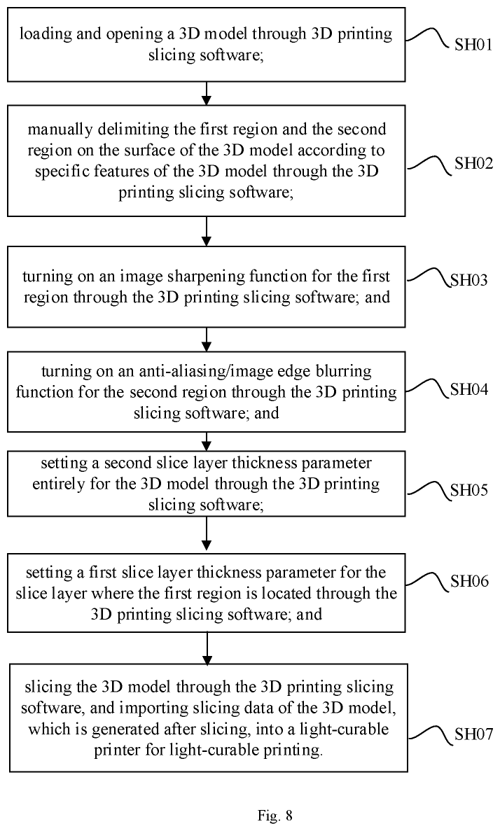

FIG. 8 is a flowchart of Method 8 for improving the fineness of a specified region on the surface of a light-curable 3D printed model according to the present invention. As shown in FIG. 8, a parallel selection mode is adopted, in which a first region and a second region are delimited on the model surface, the first region is then used as a specified region and an image sharpening function is turned on for the specified region, the second region is then used as a non-specified region and an anti-aliasing function/image edge blurring function is turned on for the non-specified region, a second layer thickness parameter is then set entirely for the model, and a first slice layer thickness parameter is then set for a slice layer where the first region is located. The Method 8 includes the following steps:
SH01: loading and opening a 3D model through 3D printing slicing software;
SH02: manually delimiting the first region and the second region on the surface of the 3D model according to specific features of the 3D model through the 3D printing slicing software;
SH03: turning on an image sharpening function for the first region through the 3D printing slicing software; and
SH04: turning on an anti-aliasing/image edge blurring function for the second region through the 3D printing slicing software; and
SH05: setting a second slice layer thickness parameter entirely for the 3D model through the 3D printing slicing software;
SH06: setting a first slice layer thickness parameter for the slice layer where the first region is located through the 3D printing slicing software; and
SH07: slicing the 3D model through the 3D printing slicing software, and importing slicing data of the 3D model, which is generated after slicing, into a light-curable printer for light-curable printing.

FIG. 9 is a puppet model diagram of a method for improving the fineness of a specified region on the surface of a light-curable 3D printed model according to the present invention. As shown in FIG. 9, at human eyes and eyebrows in a specified circle region on the puppet 3D model, their surface details and structural features are numerous, and appearance lines are more complicated. Therefore, a specific region in the specified circle region is specified as a first region, and the part of the whole except the specified circle region is specified as a second region 200.

However, in the existing light-curable 3D printing, factors affecting the appearance fineness of a printed model are mainly affected by two aspects: firstly, in a Z-axis direction, the larger the layer thickness when a slice is set, the more obvious the sense of stepped teeth on the surface of the printed model in the Z-axis direction; and secondly, affected by a pixel resolution of a mask translucent screen on an XY plane, the lower the resolution, the more obvious marginal sawteeth on a mask image produced by UV light transmission through the mask translucent screen, so the more obvious marginal sawteeth of the printed model on the XY plane.

In FIG. 9, in order to achieve the best printing effect, it is necessary to set a smaller printed layer thickness for the puppet 3D model in a Z-axis direction, and also necessary to entirely turn on an anti-aliasing/image edge blurring function for the puppet 3D model, so that the sense of marginal sawteeth on a molded resin layer of the entire model during printing is weakened, so as to improve the surface finish and flatness of the model after model printing. At the same time, it is also necessary to turn off the anti-aliasing/image edge blurring function for the human eyes and eyebrows in the specified circle region of the puppet 3D model, so that the sense of marginal sawteeth on the molded resin layer of the model involved in the specified circle region is retained, so as to improve the fineness brought by the clear sawtooth sense and clarity in the specified circle region after model printing.

FIG. 10 is a model slice diagram 1 of a method for improving the fineness of a specified region on the surface of a light-curable 3D printed model according to the present invention. As shown in FIG. 10, the puppet 3D model in FIG. 9 is sliced according to a specified layer thickness on the Z axis to be divided into layers 001-015. In addition, the specified circle regions at the human eyes and eyebrows on the puppet 3D model in FIG. 9 are exactly within slices of layers 008, 009, and 010.

FIG. 11 is a specific slice diagram of a method for improving the fineness of a specified region on the surface of a light-curable 3D printed model according to the present invention. As shown in FIG. 11, slices of layers 008, 009, and 010 containing the specified circle regions are shown in FIG. 11 on the basis of FIG. 10, and the surface details and structural features at the human eyes and eyebrows on the specified circle regions and the puppet 3D model are equally divided into three layers by these three layers of slices.

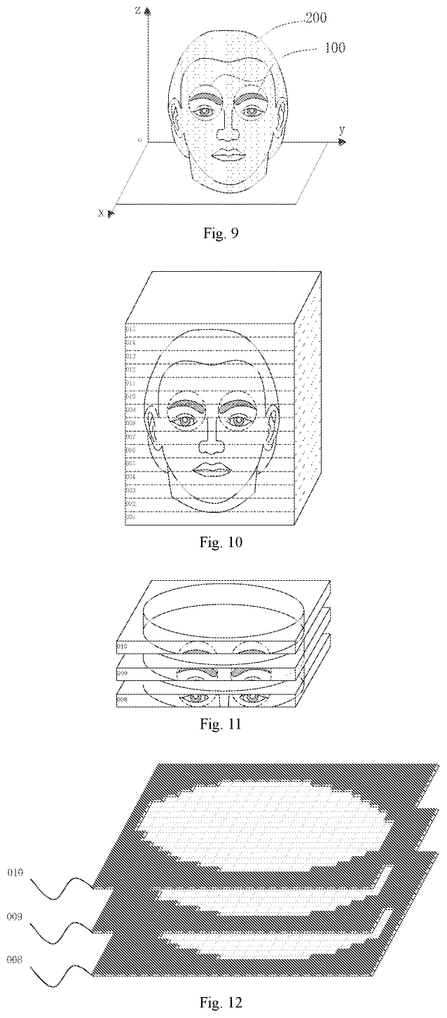

FIG. 12 is a slice mask diagram 1 of a method for improving the fineness of a specified region on the surface of a light-curable 3D printed model according to the present invention. As shown in FIG. 12, on the basis of FIG. 11, slices of layers 008, 009, 010 each contain a mask image of an XY plane. If an anti-aliasing function/image edge blurring function is turned on for the mask image, marginal sawteeth on the mask image are blurred, while marginal sawteeth on a molded resin layer of the model in the course of printing are also blurred. If an image sharpening function is turned on/an anti-aliasing function is turned off/an image edge blurring function is turned off for the mask image, the marginal sawteeth of the mask image are clear, while the marginal sawteeth on the molded resin layer of the model in the course of printing are also clear.

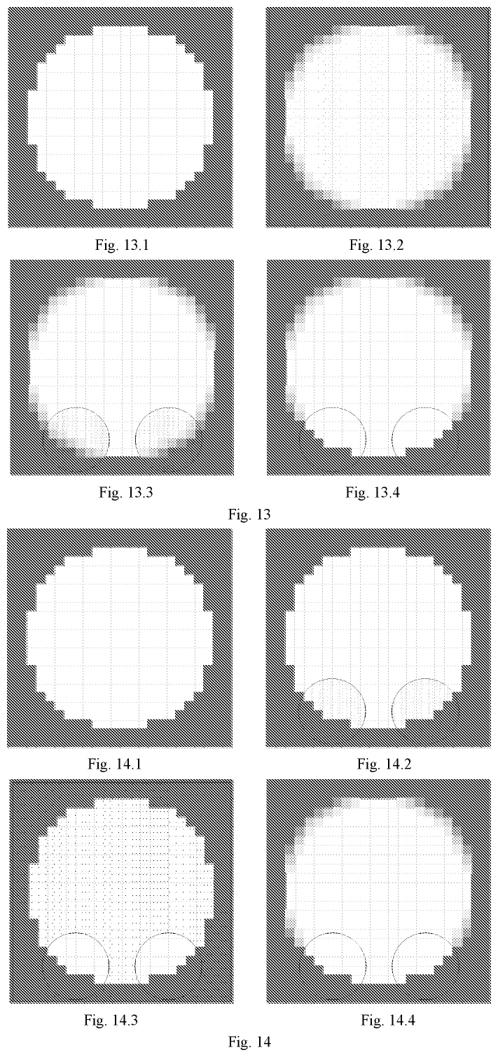

FIG. 13 is an embodiment of Method 1 or 5 for improving the fineness of a specified region on the surface of a light-curable 3D printed model according to the present invention. A state of a mask image brought by Method 1 or 5 of the present invention is demonstrated in FIG. 13 on the basis of FIG. 12 or FIG. 18 by taking a mask image of layer 9 arbitrarily taken from slices of layers as an example. However, FIG. 13 is specifically divided into four FIGS. 13.1-13.4, to demonstrate the state of the mask image.

FIG. 13.1 shows a state of the mask image of the slice of layer 009 when an anti-aliasing function is not turned on and the image edge blurring function is not turned on after the 3D model is loaded and opened by 3D printing slicing software.

FIG. 13.2 shows a state of the mask image of the slice of layer 009 when the anti-aliasing function is turned on or the image edge blurring function is turned on for the 3D model through the 3D printing slicing software, in which a black box and its black dotfill in FIG. 13.2, as an overall region, indicate that the mask image of the slice of the entire layer 009 is selected correspondingly when the function is turned on entirely for the 3D model.

FIG. 13.3 shows a state of the mask image of the slice of layer 009 when a first region is manually delimited on the surface of the 3D model through the 3D printing slicing software according to specific features of the 3D model, in which a black circle and its black dotfill serve as the first region.

FIG. 13.4 shows a state of the mask image of the slice of layer 009 after a first region is manually delimited on the surface of the 3D model through the 3D printing slicing software and after an anti-aliasing function is turned off or the image edge blurring function is turned off for the first region, in which a mask image in a dotted black circle no longer has a sawtooth edge with a grayscale gradient, and a sawtooth edge on the image at the black and white junction is clearly contrasted in black and white, which corresponds exactly to the human eyes and eyebrows of the puppet 3D model in FIG. 9. However, a mask image outside the dotted black circle still maintains an anti-aliasing/image edge blurring state. Then, mask image data in FIG. 13.4 is imported into a light-curable printer for light-curable printing, and a molded resin layer of the model at layer 009 may be obtained, wherein the sawtooth sense at positions around the human eyes and eyebrows of the molded resin layer is clear, while the edges at rest positions are flat and smooth.

FIG. 14 is an embodiment of Method 2 or 6 for improving the fineness of a specified region on the surface of a light-curable 3D printed model according to the present invention. A state of a mask image brought by Method 2 or 6 of the present invention is demonstrated in FIG. 14 on the basis of FIG. 12 or FIG. 18 by taking a mask image of layer 009 arbitrarily taken from slices of layers as an example. However, FIG. 14 is specifically divided into four FIGS. 14.1-14.4, to demonstrate the state of the mask image.

FIG. 14.1 shows a state of the mask image of the slice of layer 009 when an anti-aliasing function is not turned on and the image edge blurring function is not turned on after the 3D model is loaded and opened by 3D printing slicing software.

FIG. 14.2 shows a state of the mask image of the slice of layer 009 when a first region is manually delimited on the surface of the 3D model through the 3D printing slicing software according to specific features of the 3D model, in which a black circle and its black dotfill serve as the first region.

FIG. 14.3 shows a state of the mask image of the slice of layer 009 when a second region is inversely selected on the surface of the 3D model through the 3D printing slicing software with the first region as a reference, in which a black circle and its black dotfill serve as the second region.

FIG. 14.4 shows a state of the mask image of the slice of layer 009 after the second region is inversely selected on the surface of the 3D model through the 3D printing slicing software and after an anti-aliasing function is turned on or the image edge blurring function is turned on for the second region, in which a mask image in a dotted black circle no longer has a sawtooth edge with a grayscale gradient, and a sawtooth edge of the image at the black and white junction is clearly contrasted in black and white, which corresponds exactly to the human eyes and eyebrows of the puppet 3D model in FIG. 9. However, a mask image outside the dotted black circle still maintains an anti-aliasing/image edge blurring state. Then, mask image data in FIG. 14.4 is imported into a light-curable printer for light-curable printing, and a molded resin layer of the model at layer 009 may be obtained, wherein the sawtooth sense at positions around the human eyes and eyebrows of the molded resin layer is clear, while the edges at rest positions are flat and smooth.

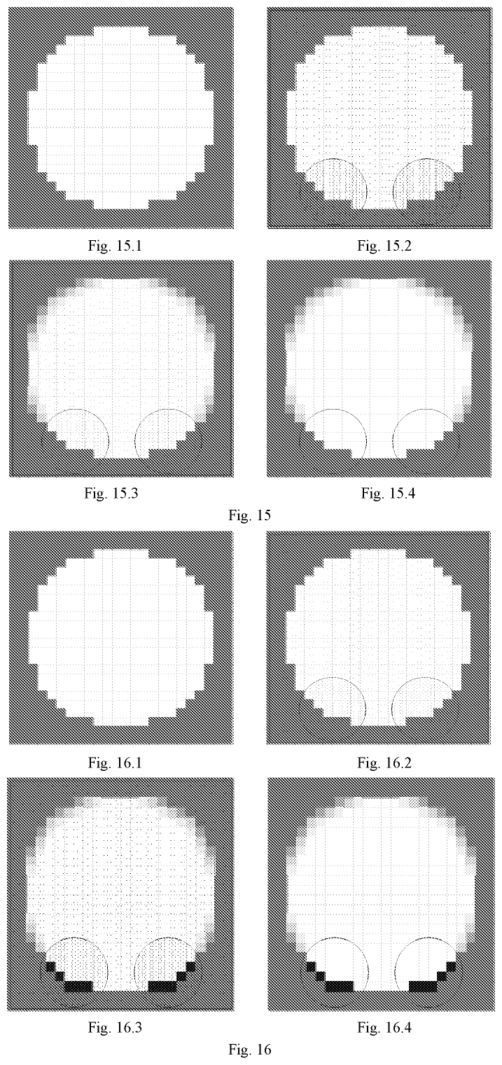

FIG. 15 is an embodiment of Method 3 or 7 for improving the fineness of a specified region on the surface of a light-curable 3D printed model according to the present invention. A state of a mask image brought by Method 3 or 7 of the present invention is demonstrated in FIG. 14 on the basis of FIG. 12 or FIG. 18 by taking a mask image of layer 009 arbitrarily taken from slices of layers as an example. However, FIG. 15 is specifically divided into four FIGS. 15.1-15.4, to demonstrate the state of the mask image.

FIG. 15.1 shows a state of the mask image of the slice of layer 009 when an anti-aliasing function is not turned on and the image edge blurring function is not turned on after the 3D model is loaded and opened by 3D printing slicing software.

FIG. 15.2 shows a state of the mask image of the slice of layer 009 when a first region and a second region are manually delimited on the surface of the 3D model through the 3D printing slicing software according to specific features of the 3D model, in which a black circle and its black dotfill serve as the first region, and a black box and its black dotfill serve as the second region.

FIG. 15.3 shows a state of the mask image of the slice of layer 009 after a first region and a second region are manually delimited on the surface of the 3D model through the 3D printing slicing software, an anti-aliasing function is not turned on/an image edge blurring function is not turned on for the first region, and the anti-aliasing function is turned on/the image edge blurring function is turned on for the second region, in which a black circle and its black dotfill serve as the first region, and a black box and its black dotfill serve as the second region.

FIG. 15.4 shows a state of the mask image of the slice of layer 009 after a first region and a second region are manually delimited on the surface of the 3D model through the 3D printing slicing software, an anti-aliasing function is not turned on/an image edge blurring function is not turned on for the first region, and the anti-aliasing function is turned on/the image edge blurring function is turned on for the second region, in which a mask image in a dotted black circle no longer has a sawtooth edge with a grayscale gradient, and a sawtooth edge of the image at the black and white junction is clearly contrasted in black and white, which corresponds exactly to the human eyes and eyebrows of the puppet 3D model in FIG. 9. However, a mask image outside the dotted black circle still maintains an anti-aliasing/image edge blurring state. Then, mask image data in FIG. 15.4 is imported into a light-curable printer for light-curable printing, and a molded resin layer of the model at layer 009 may be obtained, wherein the sawtooth sense at positions around the human eyes and eyebrows of the molded resin layer is clear, while the edges at rest positions are flat and smooth.

FIG. 16 is an embodiment of Method 4 or 8 for improving the fineness of a specified region on the surface of a light-curable 3D printed model according to the present invention. A state of a mask image brought by Method 4 or 8 of the present invention is demonstrated in FIG. 16 on the basis of FIG. 12 or FIG. 18 by taking a mask image of layer 009 arbitrarily taken from slices of layers as an example. However, FIG. 16 is specifically divided into four FIGS. 16.1-16.4, to demonstrate the state of the mask image.

FIG. 16.1 shows a state of the mask image of the slice of layer 009 when an anti-aliasing function is not turned on and the image edge blurring function is not turned on after the 3D model is loaded and opened by 3D printing slicing software.

FIG. 16.2 shows a state of the mask image of the slice of layer 009 when a first region and a second region are manually delimited on the surface of the 3D model through the 3D printing slicing software according to specific features of the 3D model, in which a black circle and its black dotfill serve as the first region, and a black box and its black dotfill serve as the second region.

FIG. 16.3 shows a state of the mask image of the slice of layer 009 after a first region and a second region are manually delimited on the surface of the 3D model through the 3D printing slicing software, an image sharpening function is turned on for the first region such that the black and white contrast of marginal sawteeth on the mask image is further enhanced, and an anti-aliasing function is turned on/an image edge blurring function is turned on for the second region, in which a black circle and its black dotfill serve as the first region, and a black box and its black dotfill serve as the second region.

FIG. 16.4 shows a state of the mask image of the slice of layer 009 after a first region and a second region are manually delimited on the surface of the 3D model through the 3D printing slicing software, an image sharpening function is turned on for the first region, and an anti-aliasing function is turned on/an image edge blurring function is turned on for the second region, in which a mask image in a dotted black circle no longer has a sawtooth edge with a grayscale gradient, and meanwhile the color of a black part on the sawtooth edge of the image at the black and white junction deepens, such that the black and white contrast is further enhanced, which corresponds exactly to the human eyes and eyebrows of the puppet 3D model in FIG. 9. However, a mask image outside the dotted black circle still maintains an anti-aliasing/image edge blurring state. Then, mask image data in FIG. 16.4 is imported into a light-curable printer for light-curable printing, and a molded resin layer of the model at layer 009 may be obtained, wherein the sawtooth sense at positions around the human eyes and eyebrows of the molded resin layer is clear, while the edges at rest positions are flat and smooth.

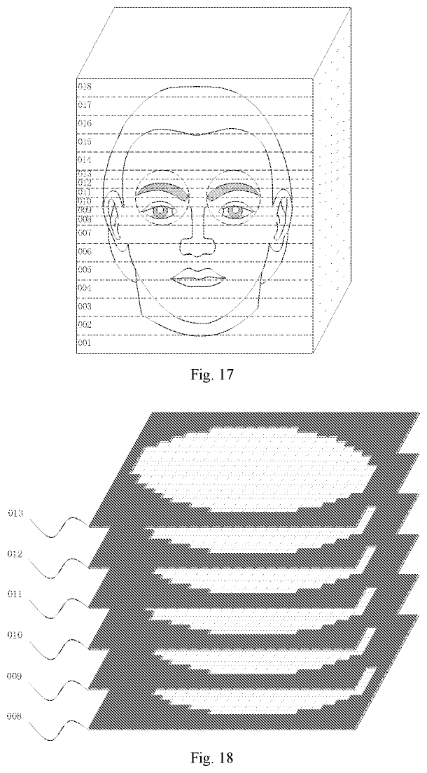

FIG. 17 is a model slice diagram 2 of a method for improving the fineness of a specified region on the surface of a light-curable 3D printed model according to the present invention. As shown in FIG. 17, on the basis of a slice having a second layer thickness parameter in FIG. 10 and in combination with Methods 5 to 8 of the present invention, a first slice layer thickness parameter is set for a slice layer where the first region is located through 3D printing slicing software; a second slice layer thickness is reduced to 50% of the original layer thickness in the slice layer region where layers 008, 009, 010 are located in FIG. 9, and then becomes a first slice layer thickness, forming new slice layers 008, 009, 010, 011, 012, 013; and the corresponding total number of slice layers changes from layers 001-015 in FIG. 9 to layers 001-018, and the serial number of each layer changes accordingly.

FIG. 18 is a slice mask diagram 2 of a method for improving the fineness of a specified region on the surface of a light-curable 3D printed model according to the present invention. As shown in FIG. 18, on the basis of FIG. 17, slices of layers 008, 009, 010, 011, 012, and 013 each contain a mask image of an XY plane again. Because a 3D printer controls ultraviolet irradiation to generate a model molded resin layer according to a mask image of each layer of slice, each layer of slice needs to contain at least one mask image of the XY plane, and the 3D printer then controls a printing lift distance of a molding platform according to the set layer thickness of each layer of slice to reserve a photosensitive resin molding space for light-curable molding of each layer of slice. Therefore, the set layer thickness of each layer of slice corresponds to the printing lift distance of the molding platform. An anti-aliasing function/image edge blurring function is then turned on for the mask image in each layer of slice, marginal sawteeth of the mask image are blurred, while marginal sawteeth on a model molded resin layer in the course of printing are also blurred. If an image sharpening function is turned on/an anti-aliasing function is turned off/an image edge blurring function is turned off for the mask image, the marginal sawteeth on the mask image are clear, while the marginal sawteeth on the model molded resin layer in the course of printing are also clear.

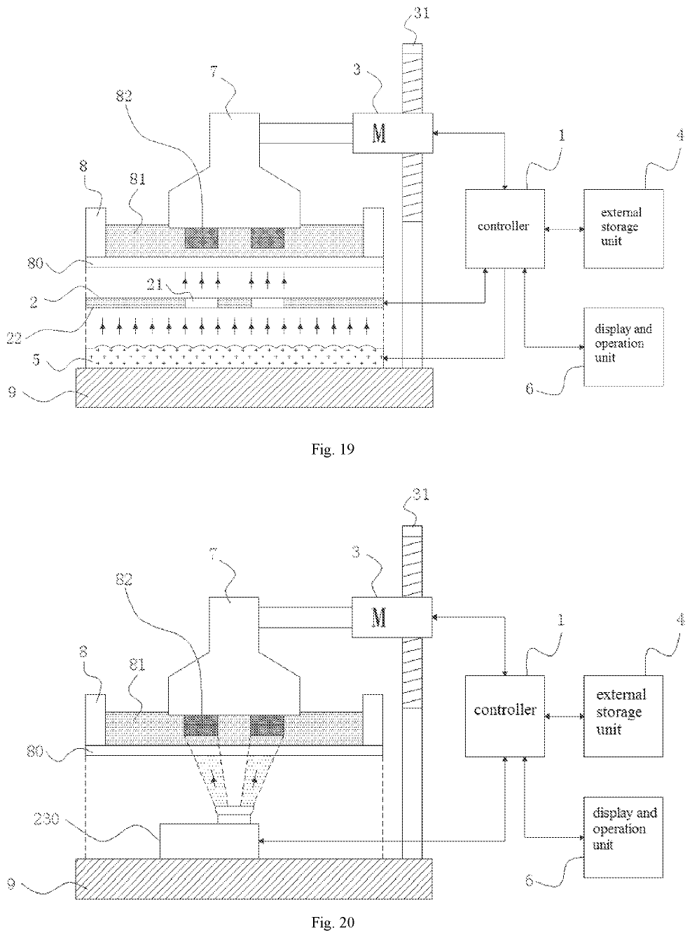

FIG. 19 is a model printing apparatus 1 for 3D model slicing data generated after slicing by a method of the present invention. As shown in FIG. 19, a motor 3 is installed in a lifting column 31 to realize electric drive lifting and drive a molding platform 7 to lift or fall accordingly. A bottom film 80 is provided at the bottom of a liquid tank 8 for light transmission. The liquid tank 8 contains a photosensitive resin 81 liquid. A controller 1 is electrically connected to an LCD screen 2, a motor 3, an external storage unit 4, an ultra violet light-emitting diode (UVLED) light source module 5, and a display and operation unit 6. The lifting column 31, the UVLED light source module 5, the LCD screen 2, and the liquid tank 8 are all fixedly connected to a base 9.

A 3D model is sliced through 3D printing preprocessing software to generate 3D model slice mask image data, printing motion execution parameters and mask image exposure time parameters, and these data files are stored in the external storage unit 4. The controller 1 reads the 3D model slice mask image data, printing motion execution parameters and mask image exposure time parameters in the external storage unit 4. The controller 1 controls the LCD screen 2 to load the 3D model slice mask image data and perform mask exposure. The controller 1 controls the motor 3 to drive the molding platform 7 to carry out a lifting motion according to the printing motion execution parameters. In response to the display and operation unit 6 issuing an operation instruction to the controller 1, the controller 1 responds to the instruction and sends control signals to control each controlled unit to complete command actions, so as to realize a human-computer interaction operation. The controller 1 outputs signals and data to the display and operation unit 6 to display a 3D model slice mask preview image, the printing motion execution parameters, the mask image exposure time parameters, system setting options and system operation parameters. The controller 1 controls the UVLED light source module 5 to light on or off. The UVLED light source module 5 emits ultraviolet light and visible light to transmit through the mask image and the bottom film 80 in the LCD screen 2 to irradiate the photosensitive resin 81 in the liquid tank 8 for exposure, such that the photosensitive resin 81 undergoes light curing reaction molding, forming a layer by layer of model molded resin layers 82. The molding platform 7 is used for attaching the cured photosensitive resin 81 during the curing molding process, so that it continues to grow until the 3D printing is completed.

FIG. 20 is a model printing apparatus 2 for 3D model slicing data generated after slicing by a method of the present invention. As shown in FIG. 20, a motor 3 is installed in a lifting column 31 to realize electric drive lifting and drive a molding platform 7 to lift or fall accordingly. A bottom film 80 is provided at the bottom of a liquid tank 8 for light transmission. The liquid tank 8 contains a photosensitive resin 81 liquid. A controller 1 is electrically connected to the motor 3, an external storage unit 4, a display and operation unit 6, and a projection apparatus 230. The lifting column 31, the projection apparatus 230 and the liquid tank 8 are all fixedly connected to a base 9.

A 3D model is sliced through 3D printing preprocessing software to generate 3D model slice mask image data, printing motion execution parameters and mask image exposure time parameters, and these data files are stored in the external storage unit 4. The controller 1 reads the 3D model slice mask image data, printing motion execution parameters and mask image exposure time parameters in the external storage unit 4. The controller 1 controls the projection apparatus 230 to load intra-layer image printing page parameters and perform mask projection according to an exposure time parameter. The controller 1 controls the motor 3 to drive the molding platform 7 to carry out a lifting motion according to the printing motion execution parameters. In response to the display and operation unit 6 issuing an operation instruction to the controller 1, the controller 1 responds to the instruction and sends control signals to control each controlled unit to complete command actions, so as to realize a human-computer interaction operation. The controller 1 outputs signals and data to the display and operation unit 6 to display a 3D model slice mask preview image, the printing motion execution parameters, the mask image exposure time parameters, system setting options and system operation parameters. The controller 1 controls the projection apparatus 230 to light up the screen after being loaded with the intra-layer image printing page parameters and perform mask projection according to the exposure time parameters, and controls the projection apparatus 230 to light off the screen. The projection apparatus 230 emits ultraviolet light and visible light projections subjected to image masking to transmit through the bottom film 80 to irradiate the photosensitive resin 81 in the liquid tank 8 for exposure, such that the photosensitive resin 81 undergoes curing molding, forming a layer by layer of model molded resin layers 82. The molding platform 7 is used for attaching the cured photosensitive resin 81 during the curing molding process, so that it continues to grow until the 3D printing is completed. The projection apparatus 230 adopts an LCD projector, or a DLP projector based on a digital micromirror device (DMD) digital micromirror technology.

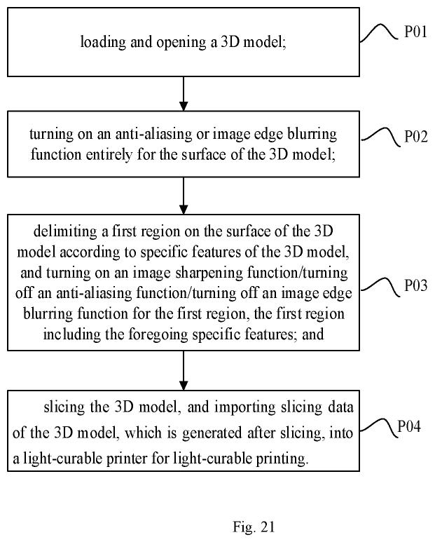

FIG. 21 is Embodiment 1 of a method for improving the fineness of a specified region on the surface of a light-curable 3D printed model according to the present invention. The method includes steps P01 to P04:
P01: loading and opening a 3D model;
P02: turning on an anti-aliasing or image edge blurring function entirely for the surface of the 3D model;
P03: delimiting a first region on the surface of the 3D model according to specific features of the 3D model, and turning on an image sharpening function/turning off an anti-aliasing function/turning off an image edge blurring function for the first region, the first region including the foregoing specific features; and
P04: slicing the 3D model, and importing slicing data of the 3D model, which is generated after slicing, into a light-curable printer for light-curable printing.

In this way, the anti-aliasing function or the image edge blurring function may be turned on entirely for the model to make the overall surface of the printed model smooth and flat. In addition, a specified region on the model surface may be circled, and the image sharpening function is turned on, or the anti-aliasing function is turned off or the image edge blurring function is turned off to retain a marginal sawtooth effect of the sliced image in the specified region, so that specific feature lines of the printed model surface are obviously prominent, and the fineness of the specific features in the specified region (the first region) of the model surface can be improved.

In some embodiments, prior to P04 (slicing the 3D model, and importing slicing data of the 3D model, which is generated after slicing, into the light-curable printer for light-curable printing), the method further includes steps L01 and L02:
L01: setting a second slice layer thickness parameter entirely for the 3D model; and
L02: setting a first slice layer thickness parameter for a slice layer where the first region is located.

In this way, thinner and smaller slice layer parameters may be set for the slice layer where the first region is located, so that the sense of stepped teeth in a Z-axis direction of the printed model surface is weaker, thereby further improving the fineness of specific features in the specified region of the model surface.

In some embodiments, the first region is a closed region. The number of the first region is one, or more. The first slice layer thickness parameter is less than or equal to the second slice layer thickness parameter. The mode of delimiting the first region includes: performing a line closure lasso selection through a line closure lasso selection tool, or performing a box selection through a box selection tool, or performing a solid intersection selection by a spherical solid intersection tool, or performing a boolean inverse selection through a Boolean selection tool, or performing a coloring selection through a coloring tool, or performing coordinate closure enclosing through inputted coordinate points, or performing a surface projection selection through a projection tool, wherein 3D model slicing data generated after the 3D model is sliced is used for light-curable printing though an LCD light-curing 3D printer, or a DLP light-curing 3D printer, or a CLIP light-curing 3D printer.

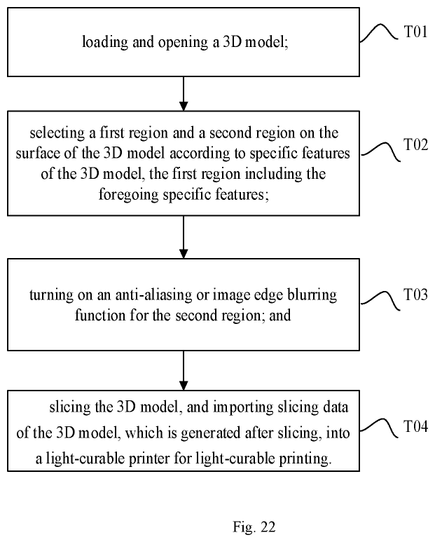

FIG. 22 is Embodiment 2 of a method for improving the fineness of a specified region on the surface of a light-curable 3D printed model according to the present invention. The method includes steps T01 to T04:
T01: loading and opening a 3D model;
T02: selecting a first region and a second region on the surface of the 3D model according to specific features of the 3D model, the first region including the foregoing specific features;
T03: turning on an anti-aliasing or image edge blurring function for the second region; and
T04: slicing the 3D model, and importing slicing data of the 3D model, which is generated after slicing, into a light-curable printer for light-curable printing.

In this way, the anti-aliasing function or the image edge blurring function may be turned on for the second region to make the overall surface of the printed model smooth and flat. In addition, a marginal sawtooth effect of the sliced image within the specified region (the first region) is retained, so that specific feature lines of the printed model surface are obviously prominent, and the fineness of the specific features in the specified region (the first region) of the model surface can be improved.

In some embodiments, T02 (selecting the first region and the second region on the surface of the 3D model according to specific features of the 3D model) includes steps T021 and T022:
T021: delimiting the first region on the surface of the 3D model; and
T022: inversely selecting the second region on the surface of the 3D model with the first region as a reference.

In other embodiments, T02 (selecting the first region and the second region on the surface of the 3D model according to specific features of the 3D model) includes: delimiting the first region and the second region on the surface of the 3D model in a parallel selection mode according to the specific features of the 3D model.

In some embodiments, prior to T04 (slicing the 3D model, and importing the slicing data of the 3D model, which is generated after slicing, into the light-curable printer for light-curable printing), the method further includes step R01:
R01: turning on an image sharpening function for the first region.

In some embodiments, prior to T04 (slicing the 3D model, and importing the slicing data of the 3D model, which is generated after slicing, into the light-curable printer for light-curable printing), the method further includes steps Q01 and Q02:
Q01: setting a second slice layer thickness parameter entirely for the 3D model; and
Q02: setting a first slice layer thickness parameter for a slice layer where the first region is located.

In this way, thinner and smaller slice layer parameters may be set for the slice layer where the first region is located, so that the sense of stepped teeth in a Z-axis direction of the printed model surface is weaker, thereby further improving the fineness of specific features in the specified region of the model surface.

In some embodiments, the first region is a closed region. The number of the first region is one, or more. The first slice layer thickness parameter is less than or equal to the second slice layer thickness parameter. The mode of delimiting the first region or the second region includes: performing a line closure lasso selection through a line closure lasso selection tool, or performing a box selection through a box selection tool, or performing a solid intersection selection by a spherical solid intersection tool, or performing a boolean inverse selection through a Boolean selection tool, or performing a coloring selection through a coloring tool, or performing coordinate closure enclosing through inputted coordinate points, or performing a surface projection selection through a projection tool, wherein 3D model slicing data generated after the 3D model is sliced is used for light-curable printing though an LCD light-curing 3D printer, or a DLP light-curing 3D printer, or a CLIP light-curing 3D printer.

In some embodiments, an anti-aliasing level in the anti-aliasing function is level 2, or level 4, or level 8. A number of gray levels of pixels at the transition of the sawtooth edge in the anti-aliasing function is any natural number from 0 to 8. The number of levels of image blurring pixels in the image edge blurring function is 2, or 3, or 4.

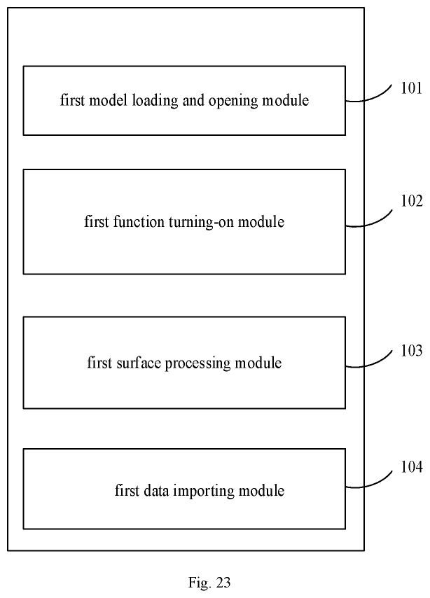

Corresponding to the method described in the above embodiment, FIG. 23 shows Embodiment 1 of an apparatus for improving the fineness of a specified region on the surface of a light-curable 3D printed model according to the present invention. For ease of description, only the parts related to the embodiments of the present invention are shown. The apparatus includes a first model loading and opening module 101, a first function turning-on module 102, a first surface processing module 103, and a first data importing module 104.

The first model loading and opening module 101 is configured to load and open a 3D model.

The first function turning-on module 102 is configured to turn on an anti-aliasing or image edge blurring function entirely for the surface of the 3D model.

The first surface processing module 103 is configured to delimit a first region on the surface of the 3D model according to specific features of the 3D model and turn on an image sharpening function/turn off an anti-aliasing function/turn off an image edge blurring function for the first region, the first region including the foregoing specific features.

The first data importing module 104 is configured to slice the 3D model, and import slicing data of the 3D model, which is generated after slicing, into a light-curable printer for light-curable printing.

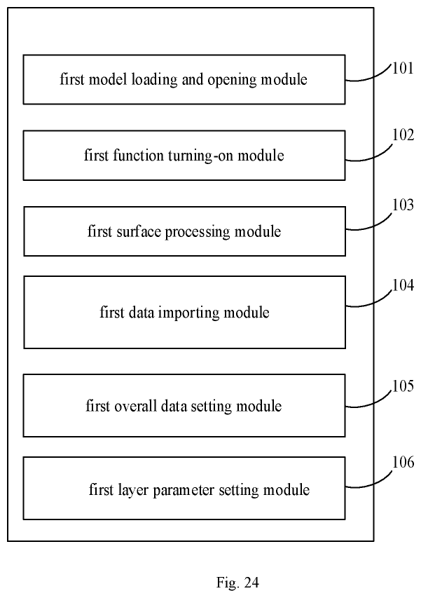

FIG. 24 is a variant of Embodiment 1 of the apparatus for improving the fineness of the specified region on the surface of the light-curable 3D printed model according to the present invention. Referring to FIG. 24, the apparatus further includes a first overall data setting module 105 and a first layer parameter setting module 106.

The first overall parameter setting module 105 is configured to set a second slice layer thickness parameter entirely for the 3D model.

The first layer parameter setting module 106 is configured to set a first slice layer thickness parameter for a slice layer where the first region is located.

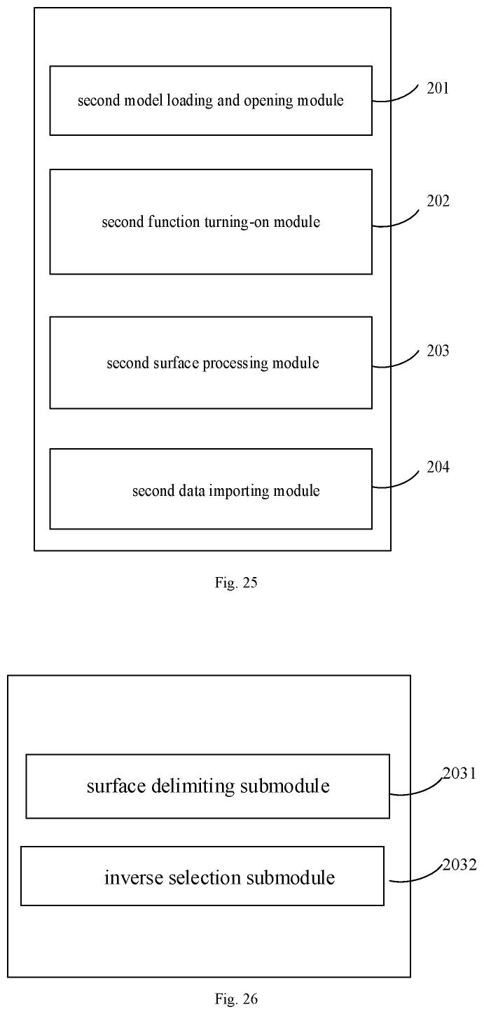

Corresponding to the method described in the above embodiment, FIG. 25 shows Embodiment 2 of an apparatus for improving the fineness of a specified region on the surface of a light-curable 3D printed model according to the present invention. For ease of description, only the parts related to the embodiments of the present invention are shown. The apparatus includes a second model loading and opening module 201, a second function turning-on module 202, a second surface processing module 203, and a second data importing module 204.

The second model loading and opening module 201 is configured to load and open a 3D model.

The second function turning-on module 202 is configured to turn on an anti-aliasing or image edge blurring function for a second region.

The second surface processing module 203 is configured to select a first region and a second region on the surface of the 3D model according to specific features of the 3D model, the first region including the foregoing specific features.

The second data importing module 204 is configured to slice the 3D model, and import slicing data of the 3D model, which is generated after slicing, into a light-curable printer for light-curable printing.

FIG. 26 is a schematic structural diagram of a second surface processing module provided by an embodiment of the present invention. Referring to FIG. 26, the second surface processing module 203 includes a surface delimiting submodule 2031 and an inverse selection submodule 2032.

The surface delimiting submodule 2031 is configured to delimit a first region on the surface of a 3D model.

The inverse selection submodule 2032 is configured to inversely select a second region on the surface of the 3D model with the first region as a reference.

In some embodiments, the second surface processing module 203 is specifically configured to delimit the first region and the second region on the surface of the 3D model in a parallel selection mode according to specific features of the 3D model.

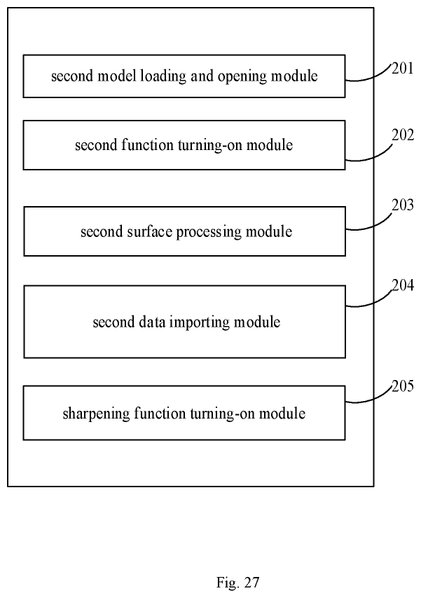

FIG. 27 is a variant of Embodiment 2 of the apparatus for improving the fineness of the specified region on the surface of the light-curable 3D printed model according to the present invention. Referring to FIG. 27, the apparatus further includes a sharpening function turning-on module 205.

The sharpening function turning-on module 205 is configured to turn on an image sharpening function for a first region.

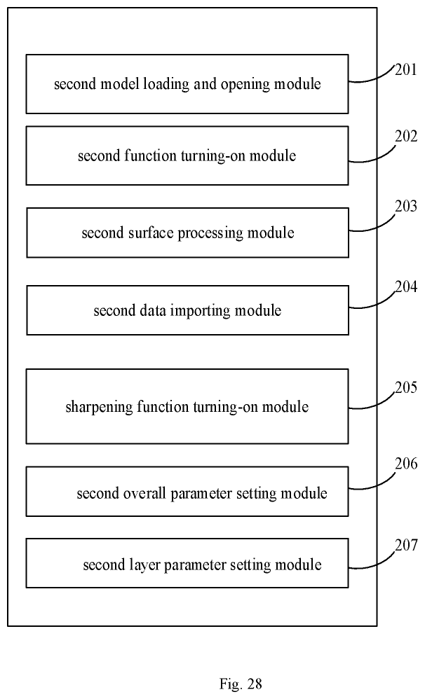

FIG. 28 is another variant of Embodiment 2 of the apparatus for improving the fineness of the specified region on the surface of the light-curable 3D printed model according to the present invention. Referring to FIG. 28, the apparatus further includes a second overall parameter setting module 206 and a second layer parameter setting module 207.

The second overall parameter setting module 206 is configured to set a second slice layer thickness parameter entirely for the 3D model.

The second layer parameter setting module 207 is configured to set a first slice layer thickness parameter for a slice layer where the first region is located.

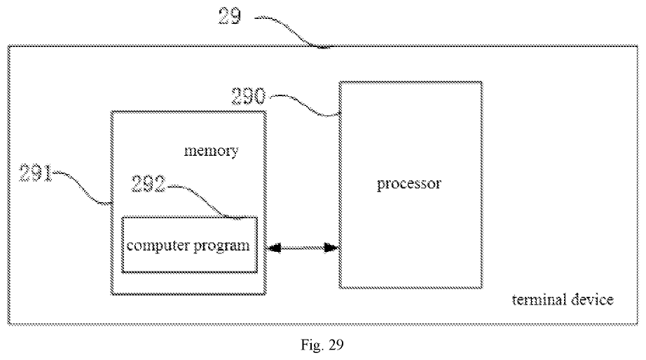

FIG. 29 is a schematic structural diagram of a terminal apparatus provided by an embodiment of the present invention. As shown in FIG. 29, the terminal device 29 of this embodiment includes at least one processor 290 (only one shown in FIG. 29), a memory 291, and a computer program 292 which is stored in the memory 291 and may run on the at least one processor 290. The processor 290 implements the steps in any of the method embodiments while executing the computer program 292.

The terminal device 29 may be a desktop computer, a notebook, a PDA, a cloud server or other computing devices. The terminal device may include, but is not limited to, a processor 290 and a memory 291. Those skilled in the art may understand that FIG. 29 is only an example of the terminal device, without constituting a limitation on the terminal device, and may include more or fewer components than shown, or a combination of certain components or different components. For example, the terminal device may further include an input/output device, a network access device, a bus, etc.

The processor 290 may be a central processing unit (CPU). The processor may also be another universal processor, a digital signal processor (DSP), an application specific integrated circuit (ASIC), a field-programmable gate array (FPGA), or other programmable logic devices, discrete gates or transistor logic devices, discrete hardware components, or the like. The universal processor may be a microprocessor, or any conventional processor.

In some embodiments, the memory 291 may be an internal storage unit of the terminal device 29, such as a hard disk or memory of the terminal device. In other embodiments, the memory 291 may also be an external storage device of the terminal device, such as a pluggable hard disk, a smart memory card (SMC), a secure digital (SD) card or a flash card equipped on the terminal device. Further, the memory 291 may also include both an internal storage unit and an external storage device of the terminal device. The memory 291 is configured to store an operating system, applications, boot loader, data, and other programs, such as program codes of computer programs. The memory 291 may also be configured to temporarily store data that has been or will be outputted.

Exemplarily, the computer program 292 may be divided into one or more modules/units, the one or more modules/units being stored in the memory 291, and executed by the processor 290 to complete the present application. The one or more modules/units may be a series of computer program instruction segments capable of completing a particular function, the instruction segments being configured to describe an execution process of the computer program 292 in the terminal device 29.

An embodiment of the present invention further provides a computer-readable storage medium configured to store a computer program therein, the computer program, when executed by a processor, being configured to implement the steps of the above method methods.

The above embodiments are only a description of the preferred embodiments of the present invention, rather than limiting the scope of the present invention. Without departing from the design spirit of the present invention, a person of ordinary skill in the art may make various deformations and improvements on the technical solutions of the present invention, which should fall within the protection scope determined by the claims of the present invention.

1. A method for improving the fineness of a specified region on the surface of a light-curable 3D printed model, comprising the following steps:
loading and opening a 3D model;
turning on an anti-aliasing or image edge blurring function for the 3D model;
delimiting a first region on the surface of the 3D model according to specific features of the 3D model, and turning on an image sharpening/turning off an anti-aliasing function/turning off an image edge blurring function for the first region, the first region comprising the specific features; and
slicing the 3D model, and importing slicing data of the 3D model, which is generated after slicing, into a light-curable printer for light-curable printing.

2. The method for improving the fineness of the specified region on the surface of the light-curable 3D printed model according to claim 1, wherein the respective steps are accomplished in 3D printing slicing software.

3. The method for improving the fineness of the specified region on the surface of the light-curable 3D printed model according to claim 1, wherein prior to slicing the 3D model and importing the slicing data of the 3D model, which is generated after slicing, into the light-curable printer for light-curable printing, further comprising:
setting a second slice layer thickness parameter entirely for the 3D model; and
setting a first slice layer thickness parameter for a slice layer where the first region is located.

4. The method for improving the fineness of the specified region on the surface of the light-curable 3D printed model according to claim 3, wherein the first region is a closed region, the number of the first region is one, or more, and the first slice layer thickness parameter is less than or equal to the second slice layer thickness parameter;
the mode of delimiting the first region comprises: performing a line closure lasso selection through a line closure lasso selection tool, or performing a box selection through a box selection tool, or performing a solid intersection selection by a spherical solid intersection tool, or performing a boolean inverse selection through a Boolean selection tool, or performing a coloring selection through a coloring tool, or performing coordinate closure enclosing through inputted coordinate points, or performing a surface projection selection through a projection tool, wherein
the 3D model slicing data generated after the 3D model is sliced is used for light-curable printing though an LCD light-curing 3D printer, or a DLP light-curing 3D printer, or a CLIP light-curing 3D printer.

5. The method for improving the fineness of the specified region on the surface of the light-curable 3D printed model according to claim 4, wherein an anti-aliasing level in the anti-aliasing function is level 2, or level 4, or level 8; the number of gray levels of pixels at the transition of the sawtooth edge in the anti-aliasing function is any natural number from 0 to 8; and the number of levels of image blurring pixels in the image edge blurring function is 2, or 3, or 4.

6. A method for improving the fineness of a specified region on the surface of a light-curable 3D printed model, comprising the following steps:
loading and opening a 3D model;
selecting a first region and a second region on the surface of the 3D model according to specific features of the 3D model, the first region comprising the specific features;
turning on an anti-aliasing or image edge blurring function for the second region; and
slicing the 3D model, and importing slicing data of the 3D model, which is generated after slicing, into a light-curable printer for light-curable printing.

7. The method for improving the fineness of the specified region on the surface of the light-curable 3D printed model according to claim 6, wherein the respective steps are accomplished in 3D printing slicing software.

8. The method for improving the fineness of the specified region on the surface of the light-curable 3D printed model according to claim 6, wherein the selecting the first region and the second region on the surface of the 3D model according to the specific features of the 3D model comprises:
delimiting a first region on the surface of the 3D model; and
inversely selecting the second region on the surface of the 3D model with the first region as a reference.

9. The method for improving the fineness of the specified region on the surface of the light-curable 3D printed model according to claim 6, wherein the selecting the first region and the second region on the surface of the 3D model according to the specific features of the 3D model comprises:
delimiting the first region and the second region on the surface of the 3D model in a parallel selection mode according to the specific features of the 3D model.

10. The method for improving the fineness of the specified region on the surface of the light-curable 3D printed model according to claim 6, wherein prior to slicing the 3D model and importing the slicing data of the 3D model, which is generated after slicing, into the light-curable printer for light-curable printing, further comprising:
turning on an image sharpening function for the first region.

11. The method for improving the fineness of the specified region on the surface of the light-curable 3D printed model according to claim 6, wherein prior to slicing the 3D model and importing the slicing data of the 3D model, which is generated after slicing, into the light-curable printer for light-curable printing, further comprising:
setting a second slice layer thickness parameter entirely for the 3D model; and
setting a first slice layer thickness parameter for the slice layer where the first region is located.

12. The method for improving the fineness of the specified region on the surface of the light-curable 3D printed model according to claim 11, wherein prior to turning on the anti-aliasing function or turning on the image edge blurring function for the second region, further comprising turning on an image sharpening function for the first region.

13. The method for improving the fineness of the specified region on the surface of the light-curable 3D printed model according to claim 12, wherein the first region is a closed region, the number of the first region is one, or more; the first slice layer thickness parameter is less than or equal to the second slice layer thickness parameter;
the mode of delimiting the first region or the second region comprises: performing a line closure lasso selection through a line closure lasso selection tool, or performing a box selection through a box selection tool, or performing a solid intersection selection by a spherical solid intersection tool, or performing a boolean inverse selection through a Boolean selection tool, or performing a coloring selection through a coloring tool, or performing coordinate closure enclosing through inputted coordinate points, or performing a surface projection selection through a projection tool, wherein
the 3D model slicing data generated after the 3D model is sliced is used for light-curable printing though an LCD light-curing 3D printer, or a DLP light-curing 3D printer, or a CLIP light-curing 3D printer.

14. The method for improving the fineness of the specified region on the surface of the light-curable 3D printed model according to claim 13, wherein an anti-aliasing level in the anti-aliasing function is level 2, or level 4, or level 8; the number of gray levels of pixels at the transition of the sawtooth edge in the anti-aliasing function is any natural number from 0 to 8; and the number of levels of image blurring pixels in the image edge blurring function is 2, or 3, or 4.

15. (canceled)

16. (canceled)

17. (canceled)

18. (canceled)

19. (canceled)

20. (canceled)

21. (canceled)

22. (canceled)
